(19) United States
(12) Patent Application Publication
(10) Pub. No.: US 2018/0285107 A1
(43) Pub. Date: Oct. 4, 2018

(54) BRANCH PREDICTION USING A PERCEPTRON-BASED BRANCH PREDICTION TECHNIQUE

(71) Applicant: International Business Machines Corporation, Armonk, NY (US)

(72) Inventors: Satish Kumar Sadasivam, Erode (IN); Puneeth A. H. Bhat, Bangalore (IN); Shruti Saxena, Bangalore (IN)

(21) Appl. No.: 15/475,192

(22) Filed: Mar. 31, 2017

(51) Int. Cl. G06F 9/30; G06F 9/38

(52) U.S. Cl. CPC G06F 9/30058; G06F 9/3867

(57) ABSTRACT

Disclosed aspects relate to branch prediction using a perceptron-based branch prediction technique in a pipelined microprocessor architecture. A first candidate branch prediction may be determined based on a single set of data of the perceptron-based branch prediction technique. A second candidate branch prediction may be determined based on the single set of data of the perceptron-based branch prediction technique, wherein the first and second candidate branch predictions differ. A chosen branch prediction may be selected using an instruction address with respect to the first and second candidate branch predictions. The chosen branch prediction may be invoked in the pipelined microprocessor architecture.

### BACKGROUND

This disclosure relates generally to computer systems and, more particularly, relates to branch prediction using a perceptron-based branch prediction technique in a pipelined microprocessor architecture. The amount of branch instructions used is increasing. As the amount of branch instructions used increases, the need for branch prediction using a perceptron-based branch prediction technique in a pipelined microprocessor architecture may also increase.

### SUMMARY

Aspects of the disclosure relate to selecting sets of weights for a reduced set of a perceptron weights vector and the overall perceptron weights vector, thereby deriving two different predictions from the same perceptron weights vector. The technique may avoid pollution of the perceptron weights vector due to static branches. Prediction accuracy for local and global branches may be enhanced and the branch misprediction rate may be reduced. The selector table may include a single level tracked based on an instruction address or multiple levels tracked both with an instruction address and global history patterns. Aspects relate to utilizing bias and most recent history weights to derive the local prediction from the perceptron table, using the selector table to select between perceptron derived local and global predictions, and enhancing the prediction accuracy of the perceptron branch predictor by reducing interference.

Disclosed aspects relate to branch prediction using a perceptron-based branch prediction technique in a pipelined microprocessor architecture. A first candidate branch prediction may be determined based on a single set of data of the perceptron-based branch prediction technique. A second candidate branch prediction may be determined based on the single set of data of the perceptron-based branch prediction technique, wherein the first and second candidate branch predictions differ. A chosen branch prediction may be selected using an instruction address with respect to the first and second candidate branch predictions. The chosen branch prediction may be invoked in the pipelined microprocessor architecture.

The above summary is not intended to describe each illustrated embodiment or every implementation of the present disclosure.

### BRIEF DESCRIPTION OF THE SEVERAL VIEWS OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a high-level block diagram of a computer system for implementing various embodiments of the present disclosure, according to embodiments.

FIG. 2 is a flowchart illustrating a method for branch prediction using a perceptron-based branch prediction technique in a pipelined microprocessor architecture, according to embodiments.

FIG. 3 is a flowchart illustrating a method for branch prediction using a perceptron-based branch prediction technique in a pipelined microprocessor architecture, according to embodiments.

FIG. 4 is a flowchart illustrating a method for branch prediction using a perceptron-based branch prediction technique in a pipelined microprocessor architecture, according to embodiments.

FIG. 5 is a flowchart illustrating a method for branch prediction using a perceptron-based branch prediction technique in a pipelined microprocessor architecture, according to embodiments.

FIG. 6 depicts an example system for branch prediction using a perceptron-based branch prediction technique in a pipelined microprocessor architecture, according to embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the disclosure relate to selecting sets of weights for a reduced set of a perceptron weights vector and the overall perceptron weights vector, thereby deriving two different predictions from the same perceptron weights vector. The technique may avoid pollution of the perceptron weights vector due to static branches. Prediction accuracy for local and global branches may be enhanced and the branch misprediction rate may be reduced. The selector table may include a single level tracked based on an instruction address or multiple levels tracked both with an instruction address and global history patterns. Aspects relate to utilizing bias and most recent history weights to derive the local prediction from the perceptron table, using the selector table to select between perceptron derived local and global predictions, and enhancing the prediction accuracy of the perceptron branch predictor by reducing interference.

In computer architecture, a branch predictor may relate to a digital circuit which predicts the direction of a conditional branch before the branch is executed. Branch predictors may enhance flow in the instruction pipeline. Branch prediction may achieve higher effective performance in pipelined microprocessor architectures. When a prediction occurs for a branch, a particular branch path of the branch is predicted. An instruction may continue in the predicted direction (path) of the branch and is speculatively executed. If the branch path was incorrectly predicted, the speculatively executed instructions may be discarded and the pipeline may start over with the correct path. Starting over may create a delay in instruction execution, causing lower performance.

Neural network machine-learning algorithms, such as multi-layer perceptron-based branch prediction techniques, may have the ability to provide enhanced prediction accuracy with reduced hardware space. Perceptron branch predictors may learn branch behavior and provide accurate predictions. Perceptron-based branch predictions may encounter difficulty for workloads with static branches and loops due to over-learning. Multiple branches sharing a perceptron weight set may pollute the perceptron weights vector and mislead overall prediction. A perceptron-based branch prediction technique may use the bias and most recent history weight to derive the local prediction from a perceptron table, use a selector table to select between the perceptron-derived local and global predictions, and enhance the prediction accuracy of the perceptron branch predictor by reducing interference.

Aspects of the disclosure relate to a system, method, and computer program product for branch prediction using a perceptron-based branch prediction technique in a pipelined microprocessor architecture. A first candidate branch prediction may be determined based on a single set of data of the perceptron-based branch prediction technique. A second candidate branch prediction may be determined based on the single set of data of the perceptron-based branch prediction technique, wherein the first and second candidate branch predictions differ. A chosen branch prediction may be selected using an instruction address with respect to the first and second candidate branch predictions. The chosen branch prediction may be invoked in the pipelined microprocessor architecture.

Aspects may relate to using a selector table to perform weight selection in perceptron-based dynamic branch prediction. In embodiments, a perceptron table with dimensions “m” and “n” may be indexed with an instruction address. A global prediction may be derived using the dot product of the weight vector and the “n” Global History register bits. In embodiments, a local prediction may be calculated using the bias and previous history and weight. A selector table may determine the actual prediction from the local or global predictions. In certain embodiments, the selector table may update when local and global predictors are different (in favor of the correct prediction). Altogether, aspects of the disclosure can have performance or efficiency benefits. Aspects may save resources such as bandwidth, disk, processing, or memory. As an example, perceptron-based branch prediction may save memory by preventing/reducing over-learning. Over-learning may result in incorrect predictions, which may result in a delay in instruction execution. Enhancing perceptron-based branch prediction may reduce over-learning, thereby reducing delays in execution and memory usage. Other examples of performance or efficiency benefits using a perceptron-based branch prediction technique in a pipelined microprocessor architecture may also be possible.

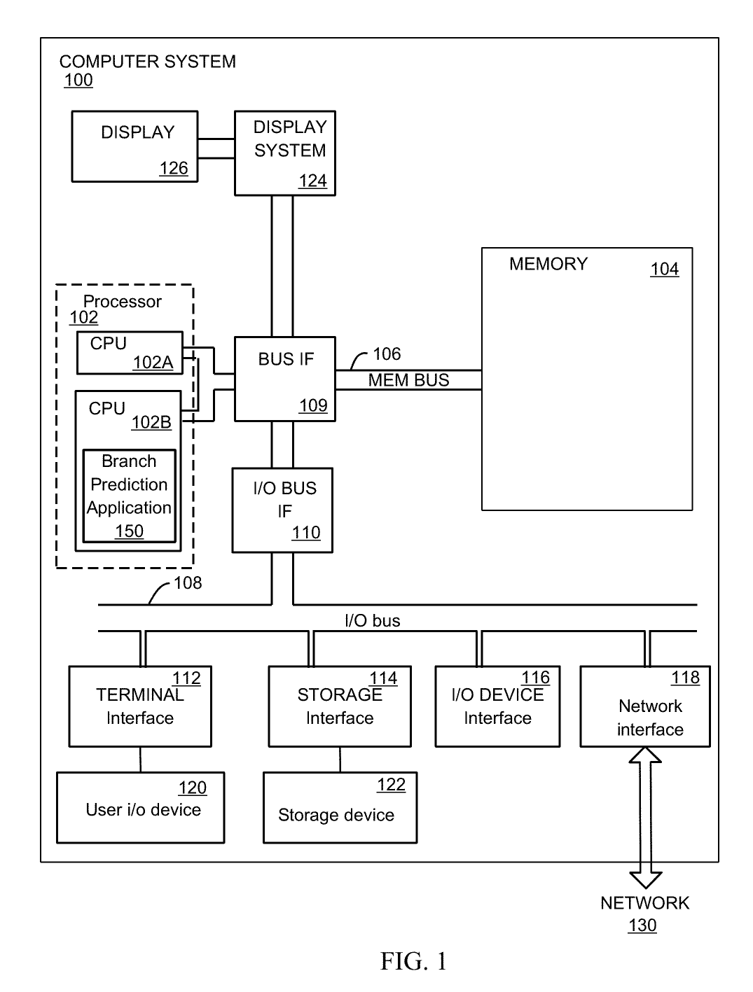

Turning now to the figures, FIG. 1 depicts a high-level block diagram of a computer system for implementing various embodiments of the present disclosure, according to embodiments. The mechanisms and apparatus of the various embodiments disclosed herein apply equally to any appropriate computing system. The major components of the computer system 100 include one or more processors 102, a memory 104, a terminal interface 112, a storage interface 114, an I/O (Input/Output) device interface 116, and a network interface 118, all of which are communicatively coupled, directly or indirectly, for inter-component communication via a memory bus 106, an I/O bus 108, bus interface unit 109, and an I/O bus interface unit 110.

The computer system 100 may contain one or more general-purpose programmable central processing units (CPUs) 102A and 102B, herein generically referred to as the processor 102. In embodiments, the computer system 100 may contain multiple processors; however, in certain embodiments, the computer system 100 may alternatively be a single CPU system. Each processor 102 executes instructions stored in the memory 104 and may include one or more levels of on-board cache.

In embodiments, the memory 104 may include a random-access semiconductor memory, storage device, or storage medium (either volatile or non-volatile) for storing or encoding data and programs. In certain embodiments, the memory 104 represents the entire virtual memory of the computer system 100, and may also include the virtual memory of other computer systems coupled to the computer system 100 or connected via a network. The memory 104 can be conceptually viewed as a single monolithic entity, but in other embodiments the memory 104 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The memory 104 may store all or a portion of the various programs, modules and data structures for processing data transfers as discussed herein. For instance, the memory 104 can store a branch prediction application 150. In embodiments, the branch prediction application 150, depicted as loaded into processor 102, may include instructions or statements that execute on the processor 102 or instructions or statements that are interpreted by instructions or statements that execute on the processor 102 to carry out the functions as further described below. In certain embodiments, the branch prediction application 150 is implemented in hardware via semiconductor devices, chips, logical gates, circuits, circuit cards, and/or other physical hardware devices in lieu of, or in addition to, a processor-based system. In embodiments, the branch prediction application 150 may include data in addition to instructions or statements.

The computer system 100 may include a bus interface unit 109 to handle communications among the processor 102, the memory 104, a display system 124, and the I/O bus interface unit 110. The I/O bus interface unit 110 may be coupled with the I/O bus 108 for transferring data to and from the various I/O units. The I/O bus interface unit 110 communicates with multiple I/O interface units 112, 114, 116, and 118, which are also known as I/O processors (IOPs) or I/O adapters (IOAs), through the I/O bus 108. The display system 124 may include a display controller, a display memory, or both. The display controller may provide video, audio, or both types of data to a display device 126. The display memory may be a dedicated memory for buffering video data. The display system 124 may be coupled with a display device 126, such as a standalone display screen, computer monitor, television, or a tablet or handheld device display. In one embodiment, the display device 126 may include one or more speakers for rendering audio. Alternatively, one or more speakers for rendering audio may be coupled with an I/O interface unit. In alternate embodiments, one or more of the functions provided by the display system 124 may be on board an integrated circuit that also includes the processor 102. In addition, one or more of the functions provided by the bus interface unit 109 may be on board an integrated circuit that also includes the processor 102.

The I/O interface units support communication with a variety of storage and I/O devices. For example, the terminal interface unit 112 supports the attachment of one or more user I/O devices 120, which may include user output devices (such as a video display device, speaker, and/or television set) and user input devices (such as a keyboard, mouse, keypad, touchpad, trackball, buttons, light pen, or other pointing device). A user may manipulate the user input devices using a user interface, in order to provide input data and commands to the user I/O device 120 and the computer system 100, and may receive output data via the user output devices. For example, a user interface may be presented via the user I/O device 120, such as displayed on a display device, played via a speaker, or printed via a printer.

The storage interface 114 supports the attachment of one or more disk drives or direct access storage devices 122 (which are typically rotating magnetic disk drive storage devices, although they could alternatively be other storage devices, including arrays of disk drives configured to appear as a single large storage device to a host computer, or solid-state drives, such as flash memory). In some embodiments, the storage device 122 may be implemented via any type of secondary storage device. The contents of the memory 104, or any portion thereof, may be stored to and retrieved from the storage device 122 as needed. The I/O device interface 116 provides an interface to any of various other I/O devices or devices of other types, such as printers or fax machines. The network interface 118 provides one or more communication paths from the computer system 100 to other digital devices and computer systems; these communication paths may include, e.g., one or more networks 130.

Although the computer system 100 shown in FIG. 1 illustrates a particular bus structure providing a direct communication path among the processors 102, the memory 104, the bus interface 109, the display system 124, and the I/O bus interface unit 110, in alternative embodiments the computer system 100 may include different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface unit 110 and the I/O bus 108 are shown as single respective units, the computer system 100 may, in fact, contain multiple I/O bus interface units 110 and/or multiple I/O buses 108. While multiple I/O interface units are shown, which separate the I/O bus 108 from various communications paths running to the various I/O devices, in other embodiments, some or all of the I/O devices are connected directly to one or more system I/O buses.

In various embodiments, the computer system 100 is a multi-user mainframe computer system, a single-user system, or a server computer or similar device that has little or no direct user interface, but receives requests from other computer systems (clients). In other embodiments, the computer system 100 may be implemented as a desktop computer, portable computer, laptop or notebook computer, tablet computer, pocket computer, telephone, smart phone, or any other suitable type of electronic device.

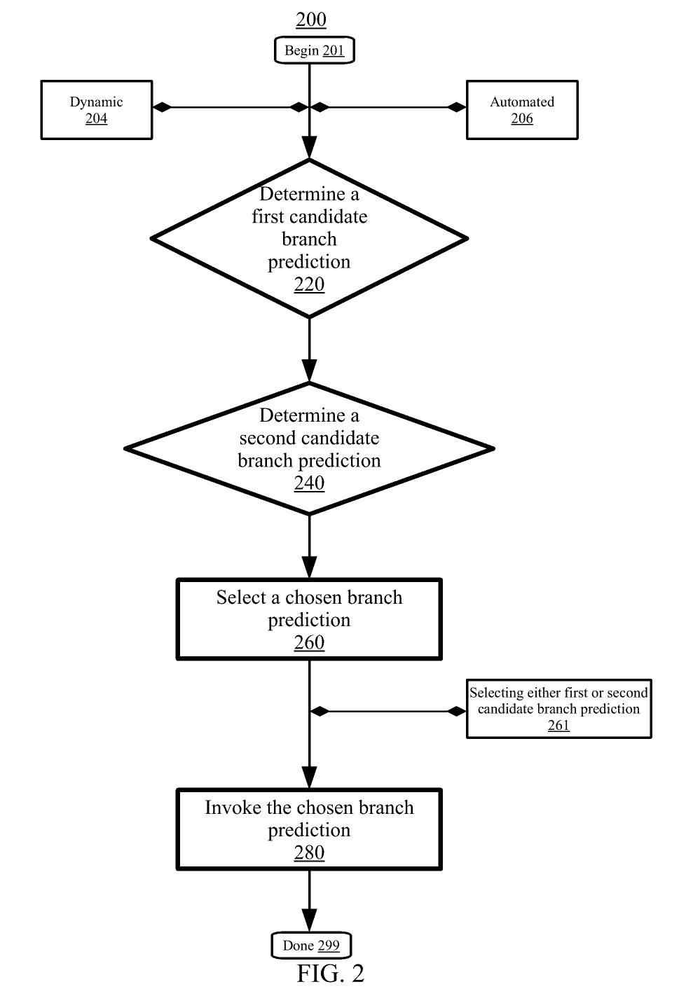

FIG. 2 is a flowchart illustrating a method 200 for branch prediction using a perceptron-based branch prediction technique in a pipelined microprocessor architecture, according to embodiments. A branch predictor may include a digital circuit which predicts the direction in which a branch will go before it is known for sure. The branch predictor may enhance the flow in modern pipelined microprocessor architectures (e.g., x86). A pipelined microprocessor may use branch prediction to collect and execute instructions along a predicted path. Perceptrons may be represented by vectors with weights for elements. Each weight may include either −ve (not taken) or +ve (taken), where ve can be any value that is preferably an integer and the values “−1” and “+1” are used herein, along with other values, as non-limiting examples. A negative output may be interpreted as “predict not taken.” A non-negative output may be interpreted as “predict taken.” Perceptron branch prediction relates to using a perceptron (e.g., neural network) to learn correlations between particular branch outcomes in the global history and the behavior of the current branch. The larger the weight, the stronger the correlation and the more that particular branch in the global history contributes to the prediction of the current branch. The method 200 may begin at block 201.

In embodiments, the determining of the first candidate branch prediction, the determining of the second candidate branch prediction, the selecting, the invoking, and the other steps described herein may each be executed in a dynamic fashion at block 204. The steps described herein may be executed in a dynamic fashion to streamline branch prediction using the perceptron-based branch prediction technique in the pipelined microprocessor architecture. The set of operational steps may occur in real-time, ongoing, or on-the-fly. As an example, one or more of the operations steps described herein may be carried-out in an ongoing basis to facilitate, promote, or enhance branch prediction using a perceptron-based branch prediction technique in a pipelined microprocessor architecture. Other examples may also be possible.

In embodiments, the determining of the first candidate branch prediction, the determining of the second candidate branch prediction, the selecting, the invoking, and the other steps described herein may each be executed in an automated fashion at block 206. The steps described herein may be executed in an automated fashion without user intervention. The operational steps may each occur in an automated fashion without user intervention or manual action (e.g., using automated computer machinery, fully machine-driven without manual stimuli). The automated operational steps may be performed by a branch prediction engine (e.g., as part of a branch prediction system), a cloud management engine (e.g., as part of a cloud environment), or the like. Other examples may also be possible.

At block 220, a first candidate branch prediction may be determined. Generally, determining can include formulating, resolving, ascertaining, identifying, or establishing. A first candidate branch prediction may include a first forecast, expectation, or projection of the route or path of an instruction execution. The determining may be performed based on a single set of data of the perceptron-based branch prediction technique. The single set of data may relate to the current instruction execution. The single set of data (e.g., perceptron weights vector) may include behaviors, features, characteristics, values, parameters, parameter values, weights, or statistics with respect to the current instruction execution. As an example, the determining may be performed based on a perceptron weights vector. The perceptron-based branch prediction technique may include a deep learning based neural technique utilized to choose the appropriate branch prediction with respect to the single set of data of the instruction execution. The perceptron weights vector may be utilized to predict branch paths with weights of −1 (not taken) or +1 (taken).

At block 240, a second candidate branch prediction may be determined. Generally, determining can include formulating, resolving, ascertaining, identifying, or establishing. The second candidate branch prediction may include a second forecast, expectation, or projection of the route or path of an instruction execution. The first and second candidate branch predictions may differ, thereby deriving two different predictions from the same/single perceptron weights vector. As an example, the first candidate branch prediction may indicate executing the instruction via Branch Path A while the second branch prediction may indicate executing the instruction via Branch Path D, where Branch Path A and Branch Path D are two different branch paths of a particular branch. In embodiments, the single perceptron branch predictor may be utilized to derive the two different predictions. In various embodiments, a single perceptron table may be utilized to derive two different predictions by selectively choosing the weights. The determining may be performed based on the single set of data (e.g., perceptron weights vector) of the perceptron-based branch prediction technique. As an example, the ability of the perceptron branch predictor may be extracted to provide two different predictions from the same weight vector.

Consider the following example. A perceptron weights vector of the perceptron-based branch prediction technique may be collected and analyzed. The perceptron weights vector may relate to an instruction execution. A first prediction may be extracted from the perceptron weights vector. The first prediction may include a designated branch path, Branch Path A. A separate second prediction may be extracted from the perceptron weights vector. The second prediction may include a different designated branch path, Branch Path B. Other examples of determining a first and second candidate branch prediction may also be possible.

At block 260, a chosen branch prediction may be selected. Generally, selecting can include choosing, specifying, resolving, electing, designating, or identifying. The chosen branch prediction may include the predicted route/path of the branch which is considered more appropriate (with respect to saving processing, memory, time, and the like) for the instruction being executed. The selecting may be performed using an instruction address with respect to the first and second candidate branch predictions. An instruction address may indicate the location of a computing device in a program sequence. The first and second candidate branch predictions may be tracked based on the location in a sequence. As an example, the first branch prediction may require less time to reach a particular location in a sequence compared to the second branch prediction. The chosen branch prediction may include the first branch prediction. Other examples may also be possible. In embodiments, the chosen branch prediction may be selected at block 261. Generally, selecting can include choosing, specifying, electing, designating, or identifying. The chosen branch prediction may be selected from the group consisting of the first candidate branch prediction and the second candidate branch prediction. The chosen branch prediction may include either the first candidate branch prediction or the second candidate branch prediction.

Consider the following example. As described herein, the branch predictions Branch Path A and Branch Path B may be extracted from the perceptron weights vector. A selector table may determine which prediction, Branch Path A or Branch Path B, is the more accurate/appropriate prediction. As an example, Branch Path B may be determined as more appropriate with respect to the instruction address. Branch Path B may save more processing and memory than Branch Path A, which may encounter an execution error. The selector may select Branch Path B as the chosen branch prediction. Other examples of selecting a chosen branch prediction using an instruction address may also be possible.

At block 280, the chosen branch prediction may be invoked. Generally, invoking can include initiating execution, executing, instantiating, carrying-out, launching, summoning, performing, or processing. A processor may invoke the chosen branch prediction by fetching branch instruction which indicates whether a branch path will be “taken” or “not taken.” If a branch path will be taken, the processor may fetch the target instructions. If a branch path will not be taken, the processor may fetch the fall-through code. The target instructions may include a command, query, or the like related to a specific operation to be processed or performed by the computing system (e.g., pipelined microprocessor). The invoking may be performed in the pipelined microprocessor architecture (e.g., via a hardware-oriented module, via firmware).

Consider the following example. As described herein, the selector table may determine that Branch Path B is the more appropriate prediction since Branch Path B saves more memory and processing. Branch Path B may be invoked in the pipelined microprocessor architecture. Branch Path B may be used to process an instruction. Other examples of invoking the chosen branch prediction may also be possible.

Method 200 concludes at block 299. Aspects of method 200 may have performance or efficiency benefits related to branch prediction using a perceptron-based branch prediction technique. Aspects may save resources such as bandwidth, disk, processing, or memory. As an example, processing may be saved by selecting a chosen branch prediction. The chosen branch prediction may be selected based on an instruction address with respect to the first and second candidate branch predictions. If one of the candidate branch predictions is determined to be more efficient based on the instruction address, that candidate branch prediction may be selected. Selecting the more efficient candidate branch prediction may save more processing time than selecting a candidate branch prediction at random or by another method. Other examples of saving processing may also be possible.

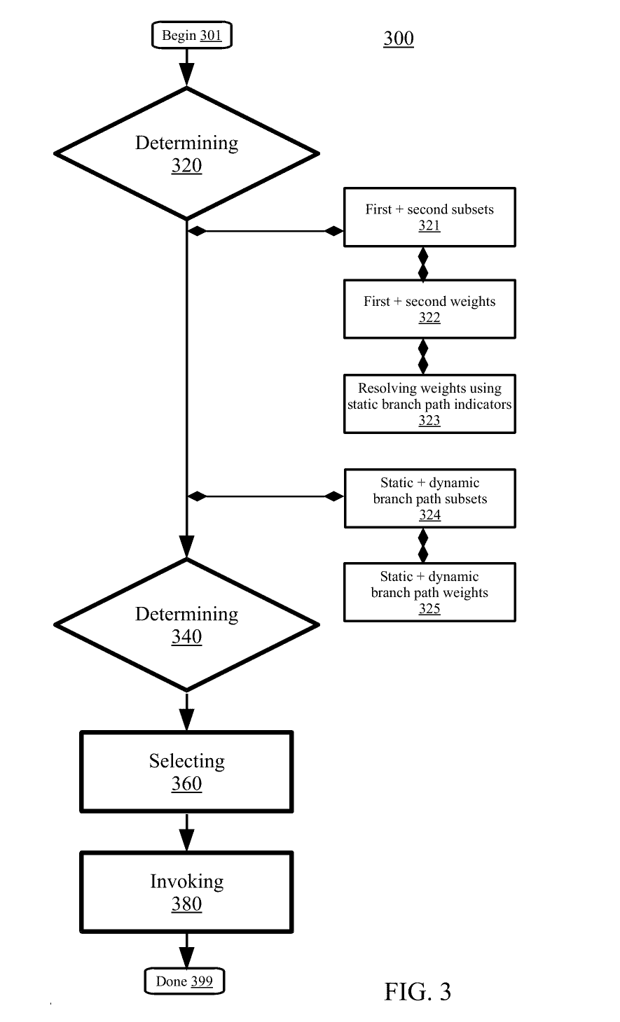

FIG. 3 is a flowchart illustrating a method 300 for branch prediction using a perceptron-based branch prediction technique in a pipelined microprocessor architecture, according to embodiments. Aspects of method 300 may be similar or the same as aspects of method 200, and aspects may be utilized interchangeably. The method 300 may begin at block 301. At block 320, a first candidate branch prediction may be determined. The determining may be performed based on a single set of data of the perceptron-based branch prediction technique. At block 340, a second candidate branch prediction may be determined. The first and second candidate branch predictions may differ. The determining may be performed based on the single set of data of the perceptron-based branch prediction technique.

In embodiments, the first candidate branch prediction may be determined at block 321. Determining can include formulating, resolving, ascertaining, identifying, or establishing. The determining may be performed using a first subset of the single set of data of the perceptron-based branch prediction technique. A first subset may include a first part, portion, subcategory, or subdivision of the single set of data. In embodiments, the first subset may include a subdivision of the perceptron weights vector. The second candidate branch prediction may be determined. Determining can include formulating, resolving, ascertaining, identifying, or establishing. The determining may be performed using a second subset of the single set of data of the perceptron-based branch prediction technique. A second subset may include a second part, portion, subcategory, or subdivision of the single set of data. The first and second subsets may differ. In embodiments, the second subset may include a subdivision of the perceptron weights vector which is different from the first subdivision. In embodiments, the first and second subsets may overlap (e.g., include some of the same elements). In certain embodiments, the first and second subsets may not overlap (e.g., do not include the same elements).

Consider the following example. The first and second candidate branch predictors may be determined using subsets of the perceptron weight vector. A first subset of the perceptron weight vector may include a subdivision of −1, −1, −1, +1, −1, −1. The first subset of the perceptron weight vector may result in a prediction of Branch Path C. A second subset of the perceptron weight vector may include a subdivision of −1, +1, +1, +1, −1. The second subset of the perceptron weight vector may differ from the first subset, and may result in a different branch prediction. The second subset of the perceptron weight vector may result in a prediction of Branch Path D. Based on the instruction address, Branch Path C may be selected as the chosen branch predictor due to greater reliability or performance. The instruction address may be executed using Branch Path C. Other examples of using a first and second subset to determine the first and second candidate branch prediction may also be possible.

In embodiments, the first candidate branch prediction may be determined at block 322. Determining can include formulating, resolving, ascertaining, identifying, or establishing. The determining may be performed using a first set of weights for the first subset of the single set of data of the perceptron-based branch prediction technique. The first set of weights may include a first factor (e.g., number, value, percentage) which indicates an importance, credibility, liability, accuracy, precision, repeatability, or the like. The second candidate branch prediction may be determined. Determining can include formulating, resolving, ascertaining, identifying, or establishing. The determining may be performed using a second set of weights for the second subset of the single set of data of the perceptron-based branch prediction technique. The second set of weights may include a second factor (e.g., number, value, percentage) which indicates an importance, credibility, liability, accuracy, precision, repeatability, or the like. The first and second sets of weights may differ. In embodiments, the second set of weights may include a number/value/percentage which is different from the first number/value/percentage.

Consider the following example. In order to determine the first and second candidate branch predictions, a first and second set of weights may be collected from the perceptron weight vector. The first set of weights extracted from the perceptron weight vector may include −1, −1, +1, +1, −1, −1, +1. The second set of weights extracted from the perceptron weight vector may include +1, +1, −1, −1, +1, +1, +1. The two sets of weights may differ and may result in two separate branch predictions. The first set of weights may result in a prediction of Branch Path E and the second set of weights may result in a prediction of Branch Path F. Branch Path F may be selected as the chosen branch predictor. Other examples of using a first and second set of weights to determine a branch prediction may also be possible.

In embodiments, the first and second weights for the first and second subsets of the single set of data of the perceptron-based branch prediction technique may be resolved at block 323. Resolving can include determining, calculating, ascertaining, establishing, or formulating. First and second weights (e.g., numbers, values, percentages) may be resolved for the established first and second subdivisions of the perceptron weights vector. The resolving may be performed using a set of static branch indicators for a set of static branch paths. Static branch prediction may relate to predicting the outcome of a branch based on the branch instruction (e.g., does not rely on dynamic history of code executing/Global History Vector). A static branch indicator may include a measure, mark, signal, or the like which provides information on the state/condition of a branch. In embodiments, the system may determine which branch paths are static and non-static. The static branch paths may be assigned a weight while the non-static branch paths may be assigned a different weight. The weights may be indicated in the perceptron table. The resolving may be performed based on filtering static branch indicators in the single set of data or the like. Filtering based on static branch paths (e.g., to weight the non-static branch paths) may avoid pollution of weights due to one or more static branch paths. As an example, the non-static branch paths may be weighted (e.g., with 2) to indicate a condition of non-static.

In embodiments, the first candidate branch prediction may be determined at block 324. Determining can include formulating, resolving, ascertaining, identifying, or establishing. The determining may be performed using a reduced subset of the single set of data of the perceptron-based branch prediction technique. The reduced subset of the single set of data may include the Global History Vector bits and the perceptron weights. The reduced subset of the single set of data may be derived via the dot product of the recent Global History Vector bits and the appropriate weights in the perceptron table. The second candidate branch prediction may be determined. Determining can include formulating, resolving, ascertaining, identifying, or establishing. The determining may be performed using in totality the single set of data (e.g., the entire set of data) of the perceptron-based branch prediction technique. The totality of the single set of data may be derived via the dot product of all Global History Vector fields and all the weights in the perceptron table entry.

Consider the following example. Reduced subsets along with the totality of the single set of data may be utilized to determine the first and second candidate branch predictions. The first candidate branch prediction may determine a prediction of Branch Path G based on the reduced subset (e.g., recent Global History Vector bits). The second candidate branch prediction may determine a prediction of Branch Path H based on the entire set of Global History Vector bits. The reduced subset and the totality of the single set of data may result in two different branch predictions. The selector table may determine that Branch Path H (based on the totality) should be the chosen branch for the instruction execution. In another embodiment (e.g., for a different instruction address), Branch Path G (based on the reduced subset) may be the chosen branch for the instruction execution. Other examples of using a reduced subset and the totality of the single set of data to determine the first and second candidate branch predictions may also be possible.

In embodiments, the first candidate branch prediction may be determined at block 325. Determining can include formulating, resolving, ascertaining, identifying, or establishing. The determining may be performed using a local branch weight for the reduced subset of the single set of data of the perceptron-based branch prediction technique. The local branch weight may include a value, number, or percentage related to the reduced subset. The second candidate branch prediction may be determined. Determining can include formulating, resolving, ascertaining, identifying, or establishing. The determining may be performed using a global branch weight for the totality of the single set of data of the perceptron-based branch prediction technique. The global branch weight may include a value, number, or percentage related to the totality of the single set of data. In embodiments, different sets of weights may be selected for the reduced subset and the totality of the single set of data.

Consider the following example. Local and global branch paths may be weighted to determine the first and second candidate branch predictions. The local branch paths may be weighted with +2 to indicate local branch paths. The first candidate branch prediction may determine a prediction of Branch Path I based on the local branch weight for the reduced subset. The second candidate branch prediction may determine a prediction of Branch Path J based on the global branch weight for the totality of the single set of data. The dot product of the perceptron weight vector and the corresponding weights of the local and global branch path subsets may be calculated in order to predict Branch Paths I and J. Based on the calculations, Branch Path J may be selected as the chosen branch prediction. The instruction may be executed using Branch Path J. Other examples of using local and global branch weights to determine the first and second candidate branch predictions may also be possible.

At block 360, a chosen branch prediction may be selected. The selecting may be performed using an instruction address with respect to the first and second candidate branch predictions. At block 380, the chosen branch prediction may be invoked. The invoking may be performed in the pipelined microprocessor architecture. Method 300 concludes at block 399. Aspects of method 300 may have performance or efficiency benefits related to branch prediction using a perceptron-based branch prediction technique. Aspects may save resources such as bandwidth, disk, processing, or memory. As an example, memory may be saved by using static and dynamic branch path subsets to determine candidate branch predictions. Using static and dynamic branch path subsets may avoid pollution of the weights vector, which may allow for enhanced prediction accuracy. More accurate predictions may require less memory than inaccurate or random predictions. Other examples may also be possible.

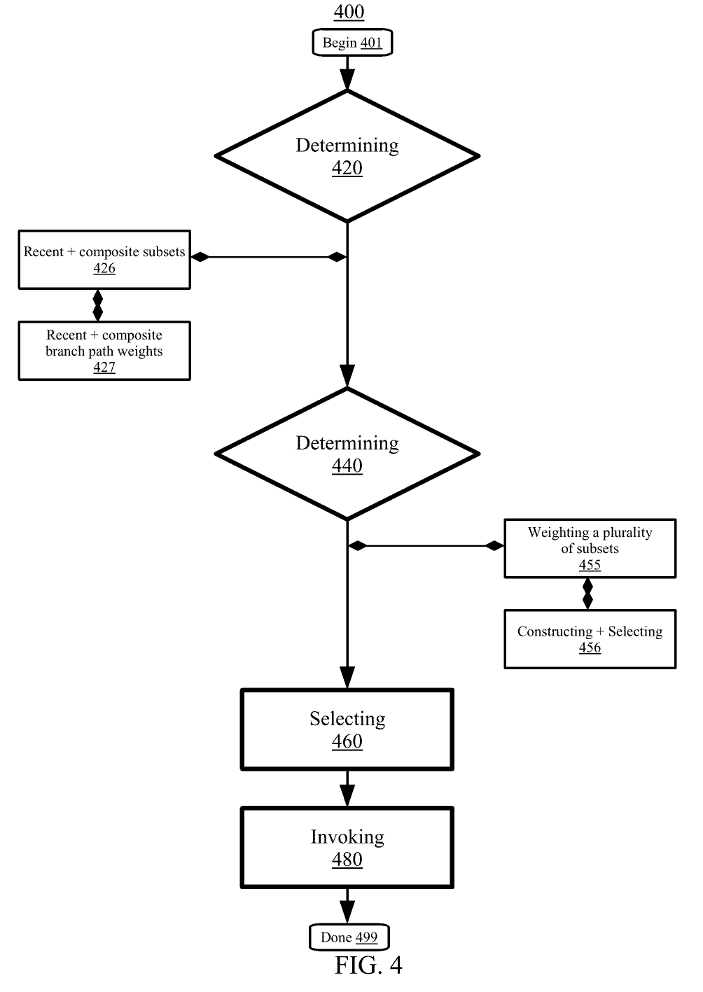

FIG. 4 is a flowchart illustrating a method 400 for branch prediction using a perceptron-based branch prediction technique in a pipelined microprocessor architecture, according to embodiments. Aspects of method 400 may be similar or the same as aspects of method 200/300, and aspects may be utilized interchangeably. The method 400 may begin at block 401. At block 420, a first candidate branch prediction may be determined. The determining may be performed based on a single set of data of the perceptron-based branch prediction technique. At block 440, a second candidate branch prediction may be determined. The first and second candidate branch predictions may differ. The determining may be performed based on the single set of data of the perceptron-based branch prediction technique.

In embodiments, the first candidate branch prediction related to a set of recent branch paths which corresponds to the recent subset of the single set of data may be determined at block 426. Determining can include formulating, resolving, ascertaining, identifying, or establishing. The determining may be performed using a recent subset of the single set of data of the perceptron-based branch prediction technique. The recent subset of the single set of data may include a group of data which is more current or up-to-date. As an example, the recent subset may include the last five, ten, or fifteen executions with respect to a set of one hundred executions. The second candidate branch prediction related to a set of composite branch paths which corresponds to the composite subset of the single set of data may be determined. Determining can include formulating, resolving, ascertaining, identifying, or establishing. The determining may be performed using a composite subset of the single set of data of the perceptron-based branch prediction technique. The composite subset of the single set of data may include an overall group of data. The composite subset may or may not include the recent subset. As an example, the composite subset may include the last twenty executions (e.g., including the last ten executions which makes up the recent subset). The Global History Vector may be utilized (e.g., weighted) to derive the local prediction from the perceptron table.

Consider the following example. A recent and a composite subset may be collected in order to determine the first and second candidate branch predictions. The dot product of the recent Global History Vector bits (e.g., the last twelve bits) and the corresponding weights may be calculated. These calculations may be utilized to determine a first candidate branch prediction of Branch Path K. The dot product of the composite/overall Global History Vector bits (e.g., one hundred bits) and the corresponding weights may be calculated. These second calculations may be utilized to determine a second candidate branch prediction of Branch Path L. Based on first and second sets of calculations, either Branch Path K or Branch Path L may be selected as the chosen branch prediction. As an example, the weight of Branch Path K may be positive (e.g., taken), and Branch Path K may be the chosen branch prediction. Other examples of using recent and composite subsets to determine the first and second candidate branch predictions may also be possible.

In embodiments, the first candidate branch prediction may be determined at block 427. Determining can include formulating, resolving, ascertaining, identifying, or establishing. The determining may be performed using a recent branch weight for the recent subset of the single set of data of the perceptron-based branch prediction technique. The recent branch weight may relate to weighting the recent branch paths (e.g., which were selected/taken/invoked) more or less heavily (e.g., than the composite branch paths). As an example, a branch path which was selected in the last five executions may be weighted more heavily than a branch path which was selected in the last thirty executions. The second candidate branch prediction may be determined. Determining can include formulating, resolving, ascertaining, identifying, or establishing. The determining may be performed using a composite branch weight for the composite subset of the single set of data of the perceptron-based branch prediction technique. The composite branch weight may relate to weighting the composite branch paths (e.g., which were taken/selected/invoked) more or less heavily (e.g., than the recent branch paths). In certain embodiments, branch paths may be weighted and ordered based on recent alone or in combination with the overall (e.g., composite). As an example, a branch path which was selected in the last fifty executions may be weighted less heavily than a branch path which was selected in the last ten executions. Other examples may also be possible.

Consider the following example. A recent and a composite subset may be collected and weighted in order to determine the first and second candidate branch predictions. The dot product of the recent Global History Vector bits (e.g., the last seven bits) and the corresponding weights may be calculated. These first calculations may be utilized to determine a first candidate branch prediction of Branch Path M. The dot product of the composite/overall Global History Vector bits (e.g., sixty bits) and the corresponding weights may be calculated. These second calculations may be utilized to determine a second candidate branch prediction of Branch Path N. Based on these first and second sets of calculations, either Branch Path M or Branch Path N may be selected as the chosen branch prediction. As an example, the weight of Branch Path M may be negative (e.g., not taken), so Branch Path N may be the chosen branch prediction. Other examples of using recent and composite branch weights to determine the first and second candidate branch predictions may also be possible.

In embodiments, a plurality of subsets of the single set of data of the perceptron-based branch prediction technique may be tracked for confidence at block 455. Tracking can include monitoring, calculating, examining, weighting, computing, or analyzing. The plurality of subsets may include one or more subgroups/subdivisions of the single set of data. The tracking may be performed using a separate set of selector data. The selector may relate to an aspect of branch prediction with the ability to learn, detect patterns, and make changes or predictions. The separate set of selector data may include a table, index, matrix, vector, or the like which organizes selector data. The separate set of selector data may be utilized to select different confidence for static/dynamic branch paths, recent/overall branch paths, or the like. In certain embodiments, the separate set of selector data may combine confidence of static, dynamic, recent, overall, and the like. As an example, a confidence may be assigned to a recent static branch path, a recent dynamic branch path, a composite static branch path, or a composite dynamic branch path.

Consider the following example. Multiple subsets may be collected from the single set of data of the perceptron-based branch prediction technique. A separate selector table may be used to weight these different sets. As an example, a first subset may be tracked based on the subset −1, +1, +1, −1. The first subset may result in a prediction of Branch Path O. A second subset may be tracked based on the subset −1, −1, −1, +1. The second subset may result in a prediction of Branch Path P. The subsets may be analyzed with respect to the instruction address. Branch Path P may be determined as the more appropriate branch prediction. Branch Path P may be utilized to execute the instruction. Other examples of tracking confidence of a plurality of subsets using a separate set of selector data may also be possible.

In embodiments, a selector data structure may be constructed at block 456. Constructing can include building, generating, configuring, establishing, organizing, arranging, programming, or setting-up. A selector data structure may include a table, index, matrix, vector, or the like to organize data. The selector data structure may include the separate set of selector data. A chosen branch prediction may be selected. Selecting can include choosing, specifying, electing, designating, or identifying as described herein. The selecting may be performed with respect to the first and second candidate branch predictions and based on the confidence. A selector table may be utilized to choose between perceptron derived local and global predictions. The correct/appropriate confidence may be selected using the selector table. A separate selection mechanism may decide between the two predictions.

In embodiments, a correct branch prediction may be ascertained. Ascertaining can include determining, establishing, discovering, or sensing. The ascertaining may be performed in response to the invoking. The correct branch predictor may be selected from the first and second candidate branch predictors. When the chosen branch prediction is invoked (e.g., initiating execution), the chosen branch predictor may be sensed, discovered, or determined. The selector data structure may be updated in response to ascertaining the correct branch prediction. Updating can include revising the selector data structure such that the selector data structure (e.g., table) learns to determine more accurate branch predictions. The confidence value may be updated based on the correctness of the chosen branch prediction. As an example, if a first candidate branch predictor is selected and determined as correct, the confidence value may be changed to +1 to indicate “high confidence for first.” If the first candidate branch predictor is selected and determined as incorrect, the confidence value may be changed to −1 to indicate “high confidence for second.” Other examples may also be possible.

Consider the following example. A selector data structure, such as a table, may be constructed to include the separate set of selector data. Weighted factors of the recent, composite, static, and dynamic subsets may be included in the selector table. These factors may be utilized to select a chosen branch prediction. As an example, the dynamic subset may be weighted and indicated in the selector table. The dynamic subset may be utilized to determine a candidate branch prediction of Branch Path Q. Based on the other weighted subsets (e.g., recent, composite, static), the selector may select Branch Path Q as the chosen branch prediction. Branch Path Q may be invoked in the pipelined microprocessor architecture. Other methods of constructing a selector data structure to select a chosen branch predictor may also be possible.

At block 460, a chosen branch prediction may be selected. The selecting may be performed using an instruction address with respect to the first and second candidate branch predictions. At block 480, the chosen branch prediction may be invoked. The invoking may be performed in the pipelined microprocessor architecture. Method 400 concludes at block 499. Aspects of method 400 may have performance or efficiency benefits related to branch prediction using a perceptron-based branch prediction technique. Aspects may save resources such as bandwidth, disk, processing, or memory. As an example, processing may be saved by determining branch predictions using static and dynamic branch weights. Categorizing and weighting the branch paths may allow for more accurate and efficient branch prediction/processing than selecting a branch prediction at random/using another method. Accurate and efficient branch prediction may save processing. Other examples of saving processing may also be possible.

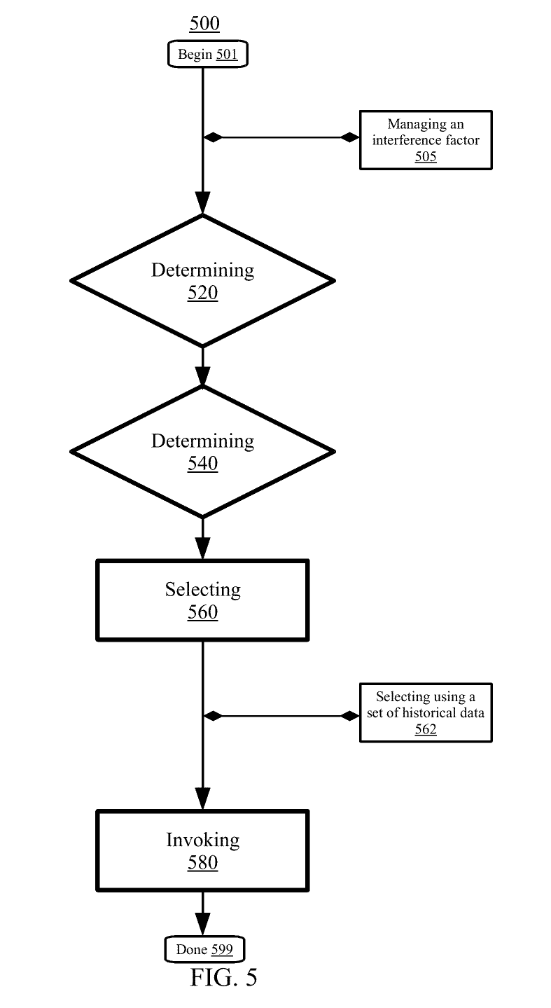

FIG. 5 is a flowchart illustrating a method 500 for branch prediction using a perceptron-based branch prediction technique in a pipelined microprocessor architecture, according to embodiments. Aspects of method 500 may be similar or the same as aspects of method 200/300/400, and aspects may be utilized interchangeably. The method 500 may begin at block 501.

In embodiments, an interference factor may be managed at block 505. Managing can include controlling, executing, guiding, operating, regulating, or organizing. The managing may be performed using a separate set of selector data. The interference factor may deter misleading learning by the perceptron-based branch prediction technique. The interference factor may prevent or reduce overlearning and false learning of the perceptron. In various embodiments, the interference factor may improve or enhance the prediction accuracy of perceptron branch predictor by reducing the interference of the selector table. In various embodiments, the interference factor may improve the prediction accuracy of the perceptron branch prediction by reducing the interference, thereby effectively tracking two or more different branch paths in the same set of weights. Other examples may also be possible.

Consider the following example. An interference factor may be managed to improve or enhance prediction accuracy of the perceptron branch prediction. In embodiments, the selector table may overlearn and select branch predictions which are inaccurate. As an example, the selector table may machine-learn that the static subset of the single set of data most often produces a correct branch prediction. The selector table may select the prediction based on the static subset by default without considering other subsets. The interference factor may be managed to allow the selector table to consider other subsets. In this example, the selector table may ignore the default of static subset and analyze the dynamic subset. The dynamic subset may establish a more accurate branch prediction for the instruction execution. The branch prediction based on the dynamic subset may be selected as the chosen branch prediction. The prediction accuracy of the perceptron branch predictor may be enhanced by reducing the interference using the selector table. Other examples of managing an interference factor may also be possible.

At block 520, a first candidate branch prediction may be determined. The determining may be performed based on a single set of data of the perceptron-based branch prediction technique. At block 540, a second candidate branch prediction may be determined. The first and second candidate branch predictions may differ. The determining may be performed based on the single set of data of the perceptron-based branch prediction technique. At block 560, a chosen branch prediction may be selected. The selecting may be performed using an instruction address with respect to the first and second candidate branch predictions.

In embodiments, the chosen branch prediction may be selected at block 562. Selecting can include choosing, specifying, electing, designating, or identifying as described herein. The selecting may be performed using a set of historical data with respect to the first and second candidate branch predictions. The set of historical data may include past, former, recent or recent data of the first and second candidate branch predictions. The set of historical data may relate to information (of the first and second candidate branch predictions) with respect to importance, credibility, liability, accuracy, precision, repeatability, or the like. As an example, the chosen branch prediction may be selected by tracking both the instruction address and the global history patterns. Other examples may also be possible.

Consider the following example. The first and second candidate branch predictions may be tracked both with the instruction address and the global history patterns. A first candidate prediction (Branch Path R) may be calculated based on the composite Global History vector and the dot product of the corresponding weights. A second candidate prediction (Branch Path S) may be calculated based on the recent Global History vector and the corresponding weights. The weight of Branch Path R may be negative (e.g., not taken) so Branch Path S may be selected as the chosen candidate branch prediction. Other methods of selecting the chosen branch prediction using a set of historical data may also be possible.

At block 580, the chosen branch prediction may be invoked. The invoking may be performed in the pipelined microprocessor architecture. Method 500 concludes at block 599. Aspects of method 500 may have performance or efficiency benefits related to branch prediction using a perceptron-based branch prediction technique. Aspects may save resources such as bandwidth, disk, processing, or memory.

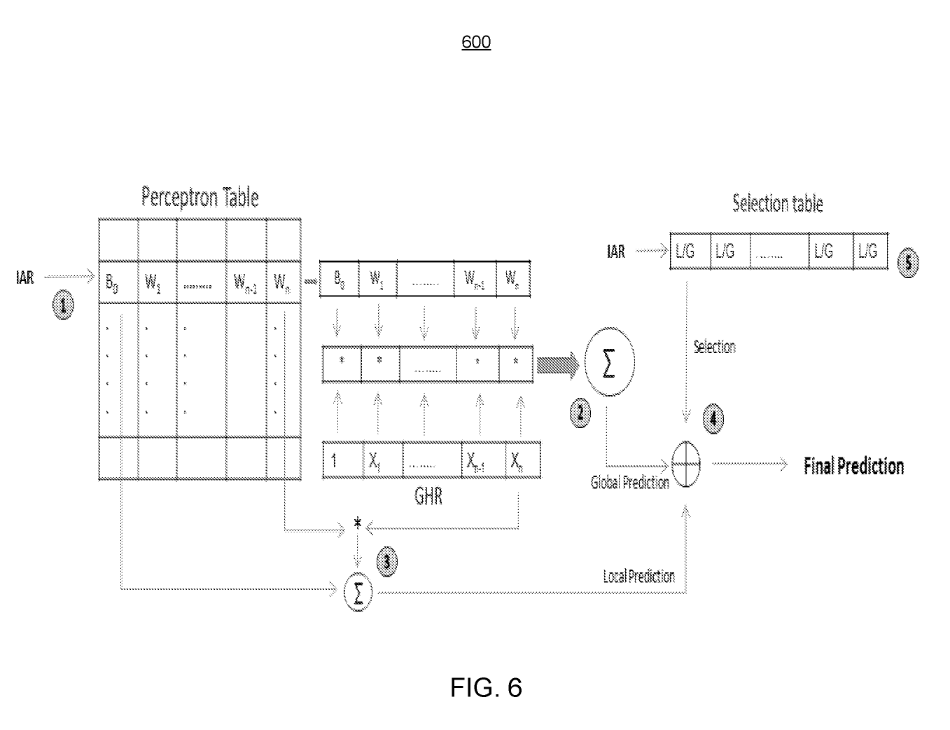

FIG. 6 depicts an example system 600 for branch prediction using a perceptron-based branch prediction technique in a pipelined microprocessor architecture, according to embodiments. A perceptron table indexed with an instruction address may be established with dimensions of “m” and “n.” The first candidate branch prediction may be determined using a first weight for a first subset of the single set of data (e.g., global history vector) of the perceptron-based branch prediction technique. The second candidate branch prediction may be determined using a second weight for a second subset of the single set of data (e.g., global history vector) of the perceptron-based branch prediction technique. The first and second subsets may or may not differ and the first and second weights may or may not differ. A static branch weight may be included in at least one of the first and second weights. A dynamic branch weight may be included in at least one of the first and second weights. A recent branch weight may be included in at least one of the first and second weights. A composite branch weight may be included in at least one of the first and second weights. In embodiments, the first candidate prediction may be derived using the dot product of the weight vector and the “n” Global History register bits. The second candidate prediction may be calculated using the bias and the previous history and weight. A selector table may determine the actual prediction from the first and second candidates. A chosen branch prediction may be selected and invoked in the pipelined microprocessor architecture. Other examples may also be possible.

In addition to embodiments described above, other embodiments having fewer operational steps, more operational steps, or different operational steps are contemplated. Also, some embodiments may perform some or all of the above operational steps in a different order. The modules are listed and described illustratively according to an embodiment and are not meant to indicate necessity of a particular module or exclusivity of other potential modules (or functions/purposes as applied to a specific module).

In the foregoing, reference is made to various embodiments. It should be understood, however, that this disclosure is not limited to the specifically described embodiments. Instead, any combination of the described features and elements, whether related to different embodiments or not, is contemplated to implement and practice this disclosure. Many modifications and variations may be apparent to those of ordinary skill in the art without departing from the scope and spirit of the described embodiments. Furthermore, although embodiments of this disclosure may achieve advantages over other possible solutions or over the prior art, whether or not a particular advantage is achieved by a given embodiment is not limiting of this disclosure. Thus, the described aspects, features, embodiments, and advantages are merely illustrative and are not considered elements or limitations of the appended claims except where explicitly recited in a claim(s).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Embodiments according to this disclosure may be provided to end-users through a cloud-computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud-computing resources are provided to a user on a pay-per-use basis, where users are charged only for the computing resources actually used (e.g., an amount of storage space used by a user or a number of virtualized systems instantiated by the user). A user can access any of the resources that reside in the cloud at any time, and from anywhere across the Internet. In context of the present disclosure, a user may access applications or related data available in the cloud. For example, the nodes used to create a stream computing application may be virtual machines hosted by a cloud service provider. Doing so allows a user to access this information from any computing system attached to a network connected to the cloud (e.g., the Internet).

Embodiments of the present disclosure may also be delivered as part of a service engagement with a client corporation, nonprofit organization, government entity, internal organizational structure, or the like. These embodiments may include configuring a computer system to perform, and deploying software, hardware, and web services that implement, some or all of the methods described herein. These embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to exemplary embodiments, other and further embodiments of the invention may be devised without departing from the basic scope thereof, and the scope thereof is determined by the claims that follow. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. “Set of,” “group of,” “bunch of,” etc. are intended to include one or more. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of exemplary embodiments of the various embodiments, reference was made to the accompanying drawings (where like numbers represent like elements), which form a part hereof, and in which is shown by way of illustration specific exemplary embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But, the various embodiments may be practiced without these specific details. In other instances, well-known circuits, structures, and techniques have not been shown in detail in order not to obscure embodiments.

1-18. (canceled)

19. A system for branch prediction using a perceptron-based branch prediction technique in a pipelined microprocessor architecture, the system comprising:
a memory having a set of computer readable computer instructions, and
a processor for executing the set of computer readable instructions, the set of computer readable instructions including:
determining, based on a single set of data of the perceptron-based branch prediction technique, a first candidate branch prediction;
determining, based on the single set of data of the perceptron-based branch prediction technique, a second candidate branch prediction, wherein the first and second candidate branch predictions differ;
selecting, using an instruction address with respect to the first and second candidate branch predictions, a chosen branch prediction; and
invoking, in the pipelined microprocessor architecture, the chosen branch prediction.

20. A computer program product for branch prediction using a perceptron-based branch prediction technique in a pipelined microprocessor architecture, the computer program product comprising a computer readable storage medium having program instructions embodied therewith, wherein the computer readable storage medium is not a transitory signal per se, the program instructions executable by a processor to cause the processor to perform a method comprising:
determining, based on a single set of data of the perceptron-based branch prediction technique, a first candidate branch prediction;
determining, based on the single set of data of the perceptron-based branch prediction technique, a second candidate branch prediction, wherein the first and second candidate branch predictions differ;
selecting, using an instruction address with respect to the first and second candidate branch predictions, a chosen branch prediction; and
invoking, in the pipelined microprocessor architecture, the chosen branch prediction.

21. The computer program product of claim 20, wherein the method further comprises:
selecting the chosen branch prediction from the group consisting of: the first candidate branch prediction and the second candidate branch prediction.

22. The computer program product of claim 20, wherein the method further comprises:
determining, using a first subset of the single set of data of the perceptron-based branch prediction technique, the first candidate branch prediction; and
determining, using a second subset of the single set of data of the perceptron-based branch prediction technique, the second candidate branch prediction, wherein the first and second subsets differ.

23. The computer program product of claim 22, wherein the method further comprises:
determining, using a first set of weights for the first subset of the single set of data of the perceptron-based branch prediction technique, the first candidate branch prediction; and
determining, using a second set of weights for the second subset of the single set of data of the perceptron-based branch prediction technique, the second candidate branch prediction, wherein the first and second sets of weights differ.

24. The computer program product of claim 20, wherein the method further comprises:
determining, using a reduced subset of the single set of data of the perceptron-based branch prediction technique, the first candidate branch prediction.

25. The computer program product of claim 24, wherein the method further comprises:
determining, using in totality the single set of data of the perceptron-based branch prediction technique, the second candidate branch prediction.

26. The computer program product of claim 25, wherein the method further comprises:
determining, using a local branch weight for the reduced subset of the single set of data of the perceptron-based branch prediction technique, the first candidate branch prediction; and
determining, using a global branch weight for the totality of the single set of data of the perceptron-based branch prediction technique, the second candidate branch prediction.

27. The computer program product of claim 20, wherein the method further comprises:
determining, using a recent subset of the single set of data of the perceptron-based branch prediction technique, the first candidate branch prediction related to a set of recent branch paths which corresponds to the recent subset of the single set of data.

28. The computer program product of claim 27, wherein the method further comprises:
determining, using a composite subset of the single set of data of the perceptron-based branch prediction technique, the second candidate branch prediction related to a set of composite branch paths which corresponds to the composite subset of the single set of data.

29. The computer program product of claim 28, wherein the method further comprises:
determining, using a recent branch weight for the recent subset of the single set of data of the perceptron-based branch prediction technique, the first candidate branch prediction; and
determining, using a composite branch weight for the composite subset of the single set of data of the perceptron-based branch prediction technique, the second candidate branch prediction.

30. The computer program product of claim 20, wherein the method further comprises:
tracking confidence, using a separate set of selector data, a plurality of subsets of the single set of data of the perceptron-based branch prediction technique.

31. The computer program product of claim 30, wherein the method further comprises:
constructing a selector data structure to include the separate set of selector data; and
selecting, with respect to the first and second candidate branch predictions and based on the confidence, a chosen branch prediction.

32. The computer program product of claim 31, wherein the method further comprises:
ascertaining, in response to the invoking, a correct branch prediction; and
updating, in response to ascertaining the correct branch prediction, the selector data structure.

33. The computer program product of claim 20, wherein the method further comprises:
selecting, using a set of historical data with respect to the first and second candidate branch predictions, the chosen branch prediction.

34. The computer program product of claim 20, wherein the method further comprises:
managing, using a separate set of selector data, an interference factor to deter misleading learning by the perceptron-based branch prediction technique.

35. The computer program product of claim 20, wherein the method further comprises:
executing, in a dynamic fashion to streamline branch prediction using the perceptron-based branch prediction technique in the pipelined microprocessor architecture, each of:
the determining of the first candidate branch prediction, the determining of the second candidate branch prediction, the selecting, and the invoking.

36. The computer program product of claim 20, wherein the method further comprises:
executing, in an automated fashion without user intervention, each of:
the determining of the first candidate branch prediction, the determining of the second candidate branch prediction, the selecting, and the invoking.

37. The computer program product of claim 20, wherein the method further comprises:
determining, using a first weight for a first subset of the single set of data of the perceptron-based branch prediction technique, the first candidate branch prediction; and
determining, using a second weight for a second subset of the single set of data of the perceptron-based branch prediction technique, the second candidate branch prediction, wherein the first and second subsets differ, wherein the first and second weights differ, and wherein
a static branch weight is included in at least one of the first and second weights,
a dynamic branch weight is included in at least one of the first and second weights,
a recent branch weight is included in at least one of the first and second weights, and
a composite branch weight is included in at least one of the first and second weights.
